(19) United States
(12) Patent Application Publication
(10) Pub. No.: US 2019/0176760 A1
(43) Pub. Date: Jun. 13, 2019

(54) VEHICLE INTERIOR MONITORING SYSTEM, STORAGE APPARATUS, AND VEHICLE

(71) Applicant: TOYOTA JIDOSHA KABUSHIKI KAISHA, Toyota-shi (JP)

(72) Inventors: Naoki UENOYAMA, Nisshin-shi (JP); Etsuko Nakajima, Nagoya-shi (JP); Junya Masui, Nagoya-shi (JP); Akira Hoshino, Nagoya-shi (JP); Hideo Hasegawa, Nagoya-shi (JP); Keiko Nakano, Kawasaki-shi (JP)

(73) Assignee: TOYOTA JIDOSHA KABUSHIKI KAISHA, Toyota-shi (JP)

(21) Appl. No.: 16/211,276

(22) Filed: Dec. 6, 2018

(30) Foreign Application Priority Data
Dec. 12, 2017 (JP) 2017-237970

(51) Int. Cl. B60R 25/30; G06K 9/00; G06Q 10/08; B60R 25/24

(52) U.S. Cl. CPC B60R 25/305; G06K 9/00832; B60R 2325/205; B60R 25/24; G06Q 10/0833

(57) ABSTRACT

A vehicle interior monitoring system is installed in a vehicle. A door of the vehicle is configured to be locked or unlocked based on a result of communication with a mobile terminal. The vehicle interior monitoring system includes an image-capturing device configured to capture an image in a vehicle cabin of the vehicle, and an interior monitoring unit configured to, when timing at which it is estimated that the number of articles or a weight of articles in the vehicle cabin has changed is first timing, acquire an image captured by the image-capturing device at second timing that comes before the first timing and acquire an image captured by the image-capturing device at third timing that comes after the first timing.

### INCORPORATION BY REFERENCE

The disclosure of Japanese Patent Application No. 2017-237970 filed on Dec. 12, 2017 including the specification, drawings and abstract is incorporated herein by reference in its entirety.

### BACKGROUND

### 1. Technical Field

The disclosure relates to a vehicle interior monitoring system, a storage apparatus, and a vehicle for temporarily storing an article.

### 2. Description of Related Art

A technique for delivering a delivered article with the use of a trunk of a receiving vehicle designated as a delivery destination by a recipient has been suggested (see, for example, Japanese Unexamined Patent Application Publication No. 2006-206225 (JP 2006-206225 A)). With this technique, when a consignee designates his or her own vehicle as a delivery destination, the consignee is allowed to receive a delivered article even during his or her absence without a delivery locker, or the like, for receiving a delivered article.

### SUMMARY

With the above-described system, a person (for example, a delivery person) who is not acquainted with an owner of a vehicle is allowed to unlock the vehicle, so the task is to ensure security. For example, with the existing system, it is not possible to check whether a package scheduled to be delivered has been properly loaded or whether loading or unloading of an article other than the scheduled package has been performed.

The disclosure ensures security in a system in which an article is loaded or unloaded through lock and unlock operations with the use of a mobile terminal.

A first aspect of the disclosure relates to a vehicle interior monitoring system. The vehicle interior monitoring system is installed in a vehicle. A door of the vehicle is configured to be locked or unlocked based on a result of communication with a mobile terminal. The vehicle interior monitoring system includes an image-capturing device configured to capture an image in a vehicle cabin of the vehicle, and an interior monitoring unit configured to acquire an image captured by the image-capturing device at second timing that comes before the first timing and acquire an image captured by the image-capturing device at third timing that comes after the first timing. The first timing is timing at which it is estimated that the number of articles or a weight of articles in the vehicle cabin has changed.

The vehicle interior monitoring system according to the first aspect of the disclosure is installed in a vehicle of which the door is configured to be locked or unlocked based on a result of communication with a mobile terminal. The vehicle may determine whether the door is allowed to be locked or unlocked by, for example, acquiring authentication information from the mobile terminal and collating the acquired authentication information with prestored authentication information. The image-capturing device captures an image in the vehicle cabin with the use of a camera, or the like. A subject to be captured may be any space as long as an article can be put in the space. A space in the vehicle cabin also includes a space that a person does not get into, such as a trunk.

The interior monitoring unit acquires an image via the image-capturing device at the plurality of timings associated with loading and unloading of an article. Specifically, the interior monitoring unit acquires an image at the second timing that comes before the first timing at which it is estimated that the number of articles or the weight of articles has changed and acquires an image at the third timing that comes after the first timing. The fact that the number of articles or the weight of articles has changed is allowed to be estimated with the use of, for example, a weight sensor, a distance sensor, or the like. The estimation may be not performed based on a result of direct sensing of the presence of an article. For example, the fact that the number of articles or the weight of articles has changed may be estimated based on an image acquired by the camera that captures an image in the vehicle cabin. The second timing and the third timing may be any timings as long as it is possible to appropriately learn that an article has been loaded or unloaded at these timings. For example, timing at which a moving object has been detected in the vehicle cabin for the first time may be set for the second timing, and timing at which the moving object has disappeared from the space in the vehicle cabin may be set for the third timing. Of course, the second timing and the third timing are not limited to these timings.

With the above configuration, since an image in the vehicle cabin is acquired at the plurality of timings around the timing at which the number of articles or the weight of articles has changed, it is possible to check whether an article has been properly unloaded or loaded (for example, whether an unintended article has been unloaded, or the like) based on the images.

The interior monitoring unit may be configured to further acquire an image captured by the image-capturing device at the first timing.

By further acquiring an image at the timing at which it is estimated that the number of articles or the weight of articles has changed, it is possible to further accurately check whether an article has been properly unloaded or loaded.

The vehicle interior monitoring system according to the first aspect of the disclosure may further include a transmitter configured to transmit the images acquired by the interior monitoring unit to a device associated with the vehicle.

The device associated with the vehicle may include, for example, a device held by an owner of the vehicle and a device that is managed by a delivery service provider to which a delivery person who holds the mobile terminal belongs. Thus, it is possible to instantaneously learn a loaded or unloaded status of an article.

The second timing may come in a period from when the door is unlocked by the mobile terminal until the first timing; and the third timing may come in a period from the first timing until the door is locked by the mobile terminal.

With the above configuration, it is possible to capture the figure of a person who enters into the vehicle cabin and the figure of a person who exits from the vehicle cabin at appropriate timing.

The vehicle interior monitoring system may further include a weight sensor provided in the vehicle cabin, and the interior monitoring unit may be configured to determine the first timing based on a signal output from the weight sensor.

By using the weight sensor, it is possible to appropriately determine timing at which an article has been put in the vehicle cabin or timing at which an article has been lifted.

The vehicle interior monitoring system according to the first aspect of the disclosure may further include a sensor configured to detect an object that enters or exits via the opened door, the second timing may be timing at which the object has been detected for a first time after the door is unlocked by the mobile terminal; and the third timing may be timing at which the object has been detected for a last time before the door is locked by the mobile terminal.

An object that exits or enters via the door is allowed to be detected with the use of, for example, an ultrasonic sensor, an infrared sensor, or the like. Instead, a sensor other than these sensors may be used. The timing at which an object has been detected for the first time after the door is unlocked coincides with the timing at which a person or an article has entered into the vehicle cabin, and the timing at which the object has been detected for the last time before the door is locked coincides with the timing at which the person or the article exits from the vehicle cabin. Thus, by using these timings, it is possible to acquire appropriate images.

The sensor may be configured to acquire a sectional area of the object that has passed through the door. The interior monitoring unit may be configured to estimate that an article has been properly loaded or unloaded by acquiring, from the sensor, sectional area information of the object that has passed through the door on a time-series basis, and collating the sectional area information with size information of the article scheduled to be loaded into the vehicle or unloaded from the vehicle.

For example, sonic waves or rays of light are irradiated in a grid pattern along an open plane of the door, and a blocked position is detected. Thus, the sectional area of an object that has passed through the door is acquired. With this configuration, it is possible to collate an object that has passed through the door with the size of an article scheduled to be loaded or unloaded. That is, it is possible to check whether a scheduled article has been properly loaded into the vehicle cabin or whether a scheduled article has been properly unloaded from the vehicle cabin.

The interior monitoring unit may be configured to collate the sectional area information at the second timing with the size information when the article is scheduled to be loaded into the vehicle.

Collation of size information at the time of loading an article is desirably performed at the second timing. This is because, when an article is loaded, it is anticipated that the article passes the door first.

A second aspect of the disclosure relates to a storage apparatus. The storage apparatus includes a lock and unlock device configured to lock or unlock the storage apparatus based on a result of communication with a mobile terminal; an estimator configured to estimate that the number of articles or a weight of articles in a predetermined space has changed; an image-capturing device configured to capture an image in the predetermined space; and an interior monitoring unit configured to acquire an image captured by the image-capturing device at second timing that comes before the first timing and acquire an image captured by the image-capturing device at third timing that comes after the first timing. The first timing is timing at which it is estimated that the number of articles or the weight of articles has changed is first timing.

A third aspect of the disclosure relates to a vehicle. The vehicle includes a lock and unlock device configured to lock or unlock a door of the vehicle based on a result of communication with a mobile terminal; an estimator configured to estimate that the number of articles or a weight of articles in a vehicle cabin has changed; an image-capturing device configured to capture an image in the vehicle cabin; and an interior monitoring unit configured to acquire an image captured by the image-capturing device at second timing that comes before the first timing and acquire an image captured by the image-capturing device at third timing that comes after the first timing. The first timing is timing at which it is estimated that the number of articles or the weight of articles has changed is first timing.

The disclosure may be specified as a vehicle or storage apparatus, including at least part of the above-described units. The disclosure may also be specified as a lock and unlock system including the vehicle or the storage apparatus. The disclosure may also be specified as a method that is executed by the vehicle or the storage apparatus. The above-described processes and units may be implemented in free combinations without any technical contradiction.

According to the aspects of the disclosure, security is ensured in the system in which an article is loaded or unloaded through lock and unlock operations with the use of a mobile terminal.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a system configuration diagram of a delivery system according to a first embodiment;

FIG. 2 is a block diagram that shows components of the delivery system according to the first embodiment;

FIG. 3 is a diagram that illustrates the placement of a camera;

FIG. 4 is a view that illustrates data flow in a first phase in the first embodiment;

FIG. 5 is a view that illustrates data flow in a second phase in the first embodiment;

FIG. 6 is a flowchart of a process of acquiring images;

FIG. 7A and FIG. 7B are views that illustrate the placement of a sensor according to a second embodiment;

FIG. 8 is a view that illustrates the output of the sensor in the second embodiment; and

FIG. 9 is a flowchart of a collation process in a third embodiment.

### DETAILED DESCRIPTION OF EMBODIMENTS

### First Embodiment

Outline of System

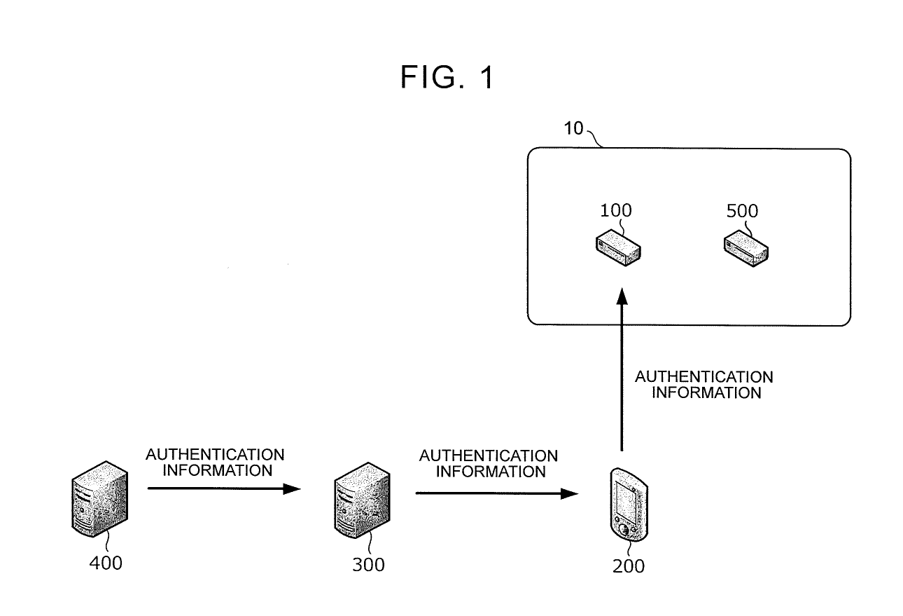

The outline of a delivery system according to a first embodiment will be described with reference to FIG. 1. The delivery system according to the present embodiment includes a lock/unlock device 100, a mobile terminal 200, a delivery management server 300, a key management server 400, and an in-vehicle device 500. In the delivery system according to the present embodiment, the lock/unlock device 100 is mounted on a vehicle 10. The lock/unlock device 100 carries out wireless communication with the mobile terminal 200 located outside the vehicle 10, and locks or unlocks the vehicle 10 based on a result of the communication. That is, a user of the system is allowed to lock or unlock the vehicle 10 with the use of only the mobile terminal 200 without using a mechanical key. The lock/unlock device 100 is an example of a lock and unlock device.

The key management server 400 is a server device that issues information (authentication information) for the lock/unlock device 100 to authenticate the mobile terminal 200. The key management server 400 issues authentication information to the mobile terminal 200 via the delivery management server 300. The lock/unlock device 100 collates the authentication information transmitted from the mobile terminal 200 with prestored authentication information. Thus, the lock/unlock device 100 authenticates the validity of the mobile terminal 200.

The delivery management server 300 is a server device that manages a plurality of the mobile terminals 200 held by delivery persons. FIG. 1 shows one mobile terminal 200 and one vehicle 10; however, the delivery management server 300 may manage a plurality of mobile terminals 200. Each mobile terminal 200 may be able to access a plurality of vehicles 10.

The in-vehicle device 500 is a device that acquires an image in a vehicle cabin when the vehicle 10 is unlocked by the mobile terminal 200 and then an article is stored.

System Configuration

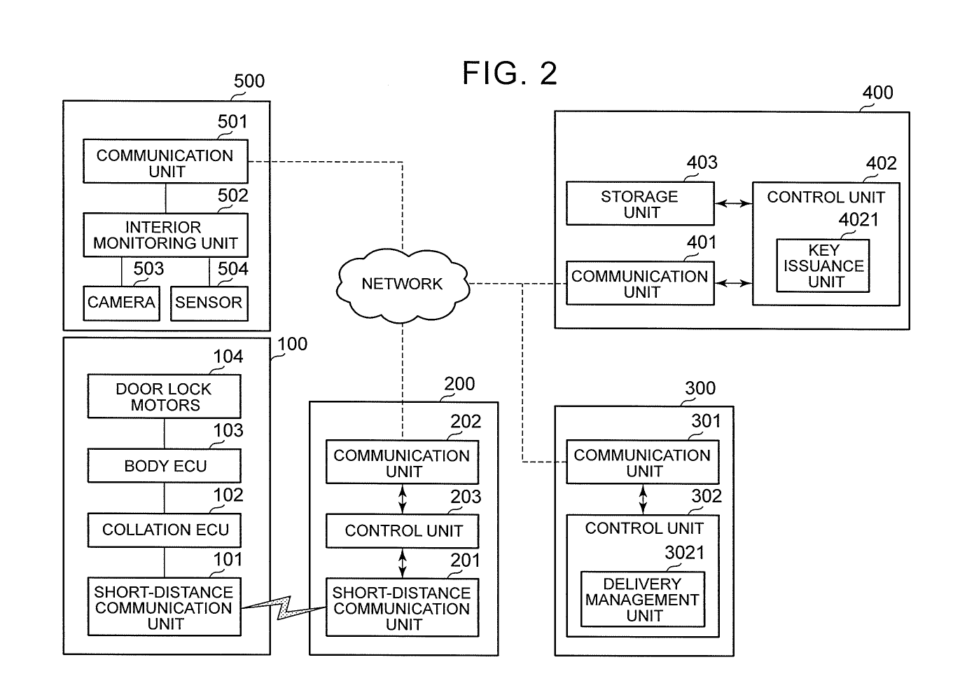

Components of the system will be described in detail. FIG. 2 is a block diagram that schematically shows an example of the configuration of the lock/unlock device 100, mobile terminal 200, delivery management server 300, key management server 400, and in-vehicle device 500, shown in FIG. 1. The lock/unlock device 100 is mounted on the vehicle 10 to be locked or unlocked.

The lock/unlock device 100 is a device for locking or unlocking the doors of the vehicle 10. Specifically, the lock/unlock device 100 locks or unlocks the doors of the vehicle 10 in response to a lock signal or unlock signal that is transmitted via radio-frequency waves from an electronic key (mobile device) held by the user of the vehicle 10. In the present embodiment, the lock/unlock device 100 has the function of locking or unlocking the doors based on a result of communication with the mobile terminal 200 in addition to the above-described function.

The lock/unlock device 100 includes a short-range communication unit 101, a collation ECU 102, a body ECU 103, and door lock motors 104. The lock/unlock device 100 operates on electric power that is supplied from an auxiliary battery (not shown) mounted on the vehicle 10. In this example, a means for carrying out communication with the electronic key is not shown.

The short-range communication unit 101 is a module that carries out communication with the mobile terminal 200 held by the user. The short-range communication unit 101 carries out communication within a short range (to such an extent that communication is available between the inside of the vehicle cabin and the outside of the vehicle cabin) with the use of predetermined wireless communication standards.

In the present embodiment, the short-range communication unit 101 carries out data communication based on Bluetooth (registered trademark) low energy (hereinafter, BLE). BLE is low-power communication standards with Bluetooth. BLE has such a characteristic that pairing is not required between devices and it is possible to immediately start communication when an intended device is detected. In the present embodiment, BLE is illustrated; however, other wireless communication standards are also usable. For example, Near field communication (NFC), Ultra wideband (UWB), Wi-Fi (registered trademark), and the like, are usable.

The collation ECU 102 is a computer that executes control for carrying out short-range wireless communication with the mobile terminal 200 via the short-range communication unit 101 and authenticating the mobile terminal 200, and that also executes control for locking or unlocking the doors of the vehicle 10 based on a result of the authentication. The collation ECU 102 is formed of, for example, a microcomputer. Functions (described later) may be implemented by running programs stored in a storage device, such as a read only memory (ROM) (not shown), on a central processing unit (CPU) (not shown).

Specifically, when the collation ECU 102 has received a lock request or an unlock request (hereinafter, collectively referred to as lock/unlock request) from the mobile terminal 200, the collation ECU 102 compares authentication information stored in the storage device (not shown) with authentication information transmitted from the mobile terminal 200. When these pieces of authentication information match with each other, the collation ECU 102 determines that authentication is successful. When both pieces of authentication information do not match with each other, the collation ECU 102 determines that authentication has failed. An authentication scheme that the collation ECU 102 uses may be a scheme through which the sameness is verified by simply comparing pieces of authentication information with each other or may be a scheme using asymmetric cryptography. Hereinafter, where necessary, authentication information that is stored in the lock/unlock device 100 is referred to as device authentication information, and authentication information that is transmitted from the mobile terminal 200 is referred to as terminal authentication information. When it is not necessary to distinguish both pieces of authentication information from each other, both pieces of authentication information are simply referred to as authentication information.

When authentication of the mobile terminal 200 is successful, the collation ECU 102 transmits an unlock instruction or a lock instruction to the body ECU 103 (described later). A signal indicating the instruction is transmitted via an in-vehicle network, such as a controller area network (CAN).

The body ECU 103 is a computer that controls the body of the vehicle 10. The body ECU 103 has the function of unlocking or locking the doors of the vehicle 10 by controlling the door lock motors 104 (described later) based on a received unlock instruction or lock instruction. The body ECU 103 may further have the functions of controlling components associated with the vehicle body, such as automatic window control, seat adjustment, antitheft control, seatbelt control, and headlight control.

The door lock motors 104 are actuators that lock or unlock the doors (not only passenger doors and a rear gate but also a trunk lid) of the vehicle 10. The door lock motors 104 operate based on a signal transmitted from the body ECU 103.

Next, the mobile terminal 200 will be described. The mobile terminal 200 is a small computer. Examples of the small computer include a smart phone, a cellular phone, a tablet terminal, a personal information terminal, a notebook computer, and a wearable computer (such as a smart watch). The mobile terminal 200 includes a short-range communication unit 201, a communication unit 202, and a control unit 203.

The short-range communication unit 201 carries out communication with the lock/unlock device 100 with the use of the same communication standards as the short-range communication unit 101. The communication unit 202 is a communication interface for connecting the mobile terminal 200 to a network. In the present embodiment, the communication unit 202 is able to carry out communication with another device via the network by using a mobile communication service, such as 3G and LTE.

The control unit 203 governs control over the mobile terminal 200. The control unit 203, for example, executes a process of generating a lock/unlock request, a process of acquiring the above-described terminal authentication information, a process of transmitting the lock/unlock request and the terminal authentication information to the lock/unlock device 100, and the like. The control unit 203 is formed of, for example, a microcomputer. The control unit 203 may implement these functions by running programs stored in a storage device (such as a ROM) (not shown) on a CPU (not shown).

The control unit 203 is connected to an input/output unit (not shown) that makes an interaction with the user. The input/output unit is formed of, for example, a touch panel, a control unit of the touch panel, a liquid crystal display, and a control unit of the liquid crystal display. In the present embodiment, the touch panel and the liquid crystal display are integrated into a single touch panel display.

The control unit 203 displays an operation page via the input/output unit, and generates an unlock request or a lock request based on an operation made by the user.

For example, the control unit 203 outputs an icon for unlocking the doors, an icon for locking the doors, and the like, on the touch panel display, and generates an unlock request or a lock request based on an operation made by the user. The operation that is made by the user is not limited to an operation via the touch panel display. For example, the operation may be, for example, an operation made via a hardware switch, or the like.

The control unit 203 executes a process of acquiring terminal authentication information. In the present embodiment, terminal authentication information is generated in the key management server 400 (described later), and is transferred to the mobile terminal 200 via the delivery management server 300 (described later). When the mobile terminal 200 has no terminal authentication information, a lock operation and an unlock operation through the operation page are disabled.

Terminal authentication information that the mobile terminal 200 acquires may be an invariant key or may be a one-time key. In any case, device authentication information corresponding to the terminal authentication information is stored in the lock/unlock device 100 in advance.

Next, the delivery management server 300 will be described. The delivery management server 300 is a server device that manages articles to be delivered and the mobile terminals 200 held by a plurality of delivery persons. The delivery management server 300 stores delivery information of an article to be delivered. When the vehicle 10 is designated as a delivery place for the article, the delivery management server 300 acquires, from the key management server 400, terminal authentication information for locking or unlocking the vehicle 10 to contain the article, and transfers the terminal authentication information to the mobile terminal 200. This process begins at a request from the mobile terminal 200 held by a delivery person. The delivery management server 300 includes a communication unit 301 and a control unit 302.

The communication unit 301, as well as the communication unit 202, is a communication interface for connection with the network, o the like. The control unit 302 governs control over the delivery management server 300. The control unit 302 is formed of, for example, a CPU. The control unit 302 includes a delivery management unit 3021 as a functional module. The functional module may be implemented by running a program stored in a storage device, such as a ROM (not shown), on the CPU (not shown).

The delivery management unit 3021 stores and manages information about users that are consignees, vehicles 10 that are delivery destinations under control of the users, articles associated with the users, and the like. As the delivery management unit 3021 receives, from the mobile terminal 200, information about an article scheduled to be delivered, the delivery management unit 3021 identifies the vehicle 10 that is a delivery destination, and submits, to the key management server 400, a request to issue terminal authentication information for locking or unlocking the vehicle 10. The delivery management unit 3021 also transfers the terminal authentication information issued by the key management server 400 to the mobile terminal 200.

Next, the key management server 400 will be described. The key management server 400 is a device that issues terminal authentication information that the mobile terminal 200 uses, in response to a request from the delivery management server 300. The key management server 400 includes a communication unit 401, a control unit 402, and a storage unit 403.

The communication unit 401, as well as the communication unit 202, is a communication interface for connection with the network.

The control unit 402 governs control over the key management server 400. The control unit 402 is formed of, for example, a CPU. The control unit 402 includes a key issuance unit 4021 as a functional module. The functional module may be implemented by running a program stored in a storage device, such as a ROM (not shown), on the CPU (not shown).

The key issuance unit 4021 issues terminal authentication information in response to a request from the delivery management server 300. As described above, the terminal authentication information is authentication information for the mobile terminal 200 to lock or unlock the vehicle 10 via the lock/unlock device 100.

Prestored terminal authentication information may be acquired or terminal authentication information may be dynamically generated. For example, authentication information that is valid only during a predetermined time period, authentication information of which the number of times of use is designated, authentication information that is usable only by the predetermined mobile terminal 200, or the like, may be generated. When the vehicle 10 has a plurality of spaces that are independently lockable and unlockable, such as the vehicle cabin and the trunk, authentication information with which only any one of the spaces is lockable and unlockable may be generated.

The storage unit 403 is formed of a storage medium, such as a RANI, a magnetic disk, and a flash memory, that stores information. Device authentication information corresponding to the lock/unlock device 100, terminal authentication information paired with the device authentication information, and various data for generating these pieces of authentication information are stored in the storage unit 403.

The in-vehicle device 500 is a monitoring device that is installed in the vehicle 10 that is unlocked by the mobile terminal 200. The in-vehicle device 500 is a device that acquires an image captured by a camera 503 provided in the vehicle cabin.

The in-vehicle device 500 includes a communication unit 501, an interior monitoring unit 502, the camera 503, and a sensor 504. The communication unit 501, as well as the communication unit 202, is a communication interface for connection with the network. The interior monitoring unit 502 acquires an image in the vehicle cabin with the use of the camera 503 and the sensor 504 (described later). The communication unit 501 is an example of a transmitter. The camera 503 is an example of an image-capturing device. The interior monitoring unit 502 may be a processor or monitoring circuitry. Specific details of a process will be described later.

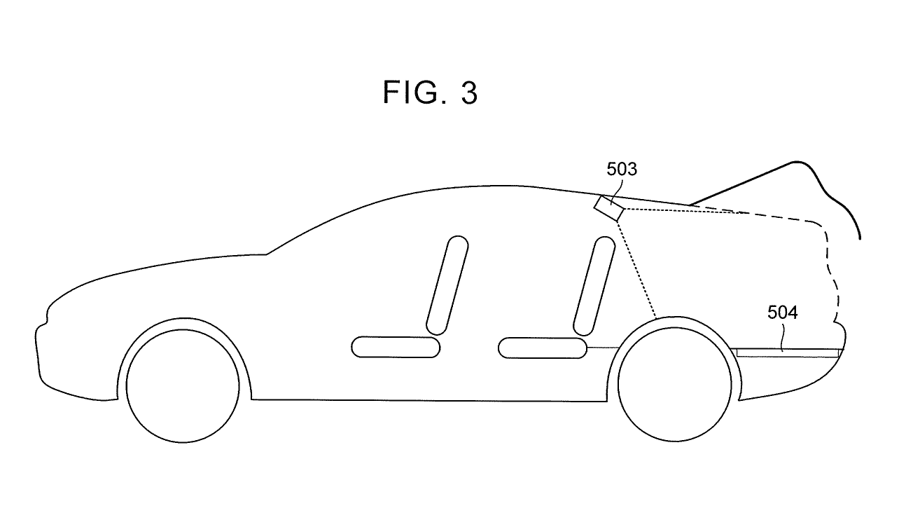

The camera 503 is a camera that captures a space in the vehicle cabin through an optical image. For example, as shown in FIG. 3, the camera 503 is disposed at a location at which the camera 503 is able to capture the image of a space in which an article is assumed to be stored. FIG. 3 illustrates a luggage space. Alternatively, the camera 503 may be disposed at a location at which the camera 503 is able to capture the image of the whole vehicle cabin. The camera 503 may be disposed at a location at which the camera 503 is able to capture the image of only part of the vehicle cabin. The camera 503 may capture an image in response to a request from the outside; however, the camera 503 is desirably configured to periodically capture an image, accumulates several images or images of several seconds, and output an image at past timing upon request. With this configuration, it is possible to acquire an image just before a person exits from the vehicle cabin with, for example, closing of the door as a trigger.

The sensor 504 is a sensor for detecting the fact that an article has been put in the vehicle cabin or the fact that an article has been taken out from the vehicle cabin. As illustrated in FIG. 3, for example, a weight sensor disposed at the bottom of the vehicle cabin may be used as the sensor 504. In the case of this example, a load in a steady state is acquired in advance, and a change in the number of articles or the weight of articles is detected by comparing the load in the steady state with a measured load. A load that the sensor 504 measures may be a load that acts on part of the vehicle 10 or may be a load that acts on the whole of the vehicle 10.

Operation to Lock or Unlock Vehicle

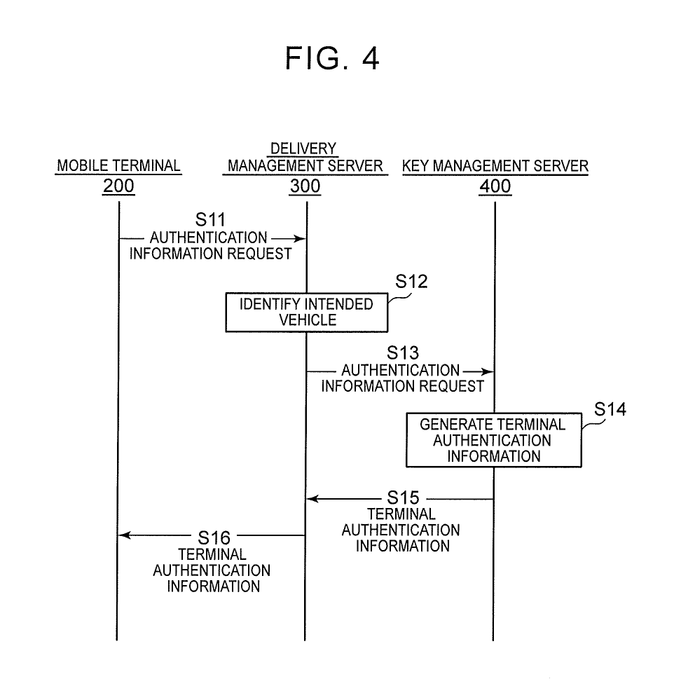

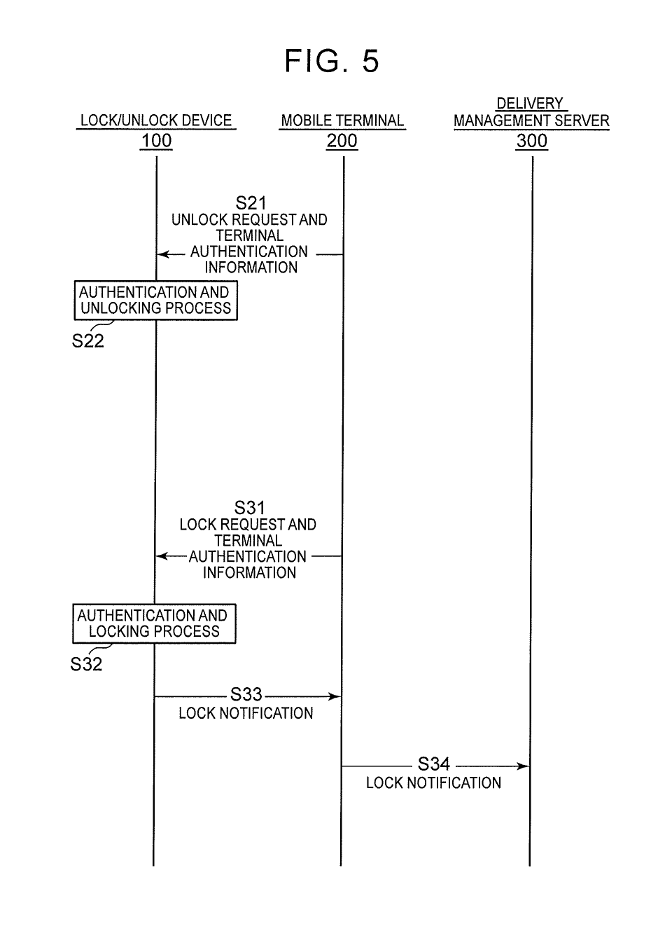

Next, a process of locking or unlocking the vehicle 10 with the use of the mobile terminal 200 will be described. The process is divided into a phase (first phase) in which the mobile terminal 200 acquires terminal authentication information and a phase (second phase) in which the mobile terminal 200 accesses the lock/unlock device 100 and locks or unlocks the vehicle 10 with the use of the acquired terminal authentication information. FIG. 4 is a view that shows the flow of data in the first phase. FIG. 5 is a view that shows the flow of data in the second phase.

The first phase will be described with reference to FIG. 4. The processes of step S11 to step S16 are executed when a request to issue terminal authentication information has been submitted from the mobile terminal 200. Initially, in step S11, the mobile terminal 200 submits a request to issue terminal authentication information to the delivery management server 300. In this step, information that identifies the mobile terminal 200 and information that identifies an article (hereinafter, package information; for example, a slip number) are transmitted at the same time as an authentication information request.

In step S12, the delivery management server 300 (delivery management unit 3021) identifies the vehicle 10 that is a delivery destination based on the acquired package information and the prestored information. Subsequently, the delivery management server 300 adds the identifier of the vehicle 10 to the authentication information request, and transmits the authentication information request to the key management server 400 (step S13).

In step S14, the key issuance unit 4021 generates (or acquires) terminal authentication information unique to the mobile terminal 200.

Subsequently, in step S15, the key management server 400 transmits the generated terminal authentication information to the delivery management server 300 (step S15). The delivery management server 300 transfers the terminal authentication information to the mobile terminal 200 (step S16). Thus, an operation to unlock the vehicle 10 with the mobile terminal 200 is enabled. In this example, terminal authentication information is transferred via the delivery management server 300. Alternatively, terminal authentication information may be directly transmitted from the key management server 400 to the mobile terminal 200.

Since the processes of step S11 to step S16 are preparation processes for locking or unlocking the vehicle 10, the processes of step S11 to step S16 are desirably executed in advance. For example, the processes of step S11 to step S16 may be executed in the stage of preparation for delivery.

The second phase will be described with reference to FIG. 5. The processes of step S21 to step S22 are processes for unlocking the vehicle 10 with the use of the mobile terminal 200. As the user of the mobile terminal 200 (that is, the delivery person) performs an operation to unlock the vehicle 10 via the input/output unit, a link is established by BLE between the mobile terminal 200 and the lock/unlock device 100. Then, in step S21, the mobile terminal 200 transmits an unlock request and the terminal authentication information to the lock/unlock device 100.

In step S22, the collation ECU 102 of the lock/unlock device 100 collates the terminal authentication information transmitted from the mobile terminal 200 with the device authentication information stored in advance, and executes an authentication process. When authentication is successful, the collation ECU 102 unlocks the doors of the vehicle 10.

The processes of step S31 to step S34 are processes for locking the vehicle 10 with the use of the mobile terminal 200. As the user of the mobile terminal 200 performs an operation to lock the vehicle 10 via a touch panel screen, the mobile terminal 200 transmits a lock request and the terminal authentication information to the lock/unlock device 100 in step S31.

In step S32, the collation ECU 102 of the lock/unlock device 100 collates the terminal authentication information transmitted from the mobile terminal 200 with the device authentication information stored in advance, and executes an authentication process. When authentication is successful, the collation ECU 102 locks the doors of the vehicle 10.

After the doors of the vehicle 10 have been locked, the body ECU 103 of the lock/unlock device 100 transmits a notification that locking of the doors of the vehicle 10 has completed (lock notification) to the mobile terminal 200 (step S33). Thus, the notification that locking of the doors of the vehicle 10 has completed is output onto the touch panel screen of the mobile terminal 200. When the terminal authentication information is a one-time key, the one-time key may be invalidated at the timing of step S33. Finally, the mobile terminal 200 transmits the lock notification to the delivery management server 300 (step S34).

Interior Monitoring Operation

Next, a process in which the in-vehicle device 500 of the vehicle 10 monitors a space in the vehicle cabin will be described. In the present embodiment, in order to monitor what a delivery person is doing, the interior monitoring unit 502 acquires a plurality of images via the camera 503 between step S22 to step S32, shown in FIG. 5.

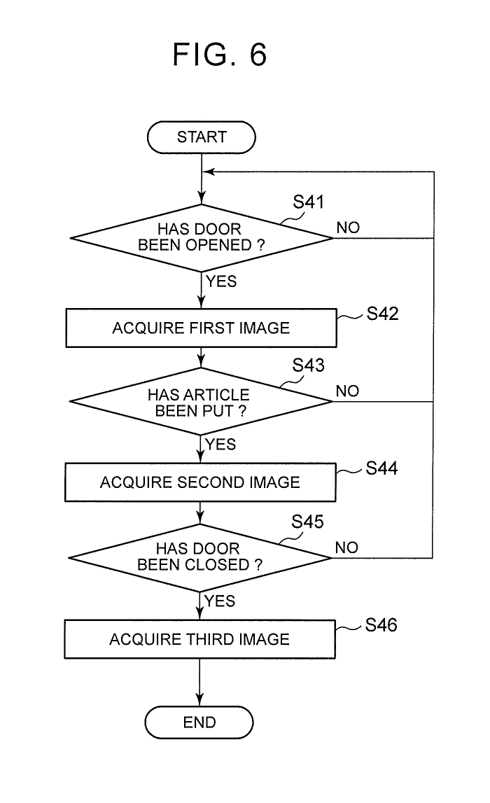

FIG. 6 is a flowchart of the process in which the in-vehicle device 500 monitors a space in the vehicle cabin. The process shown in FIG. 6 is started by the interior monitoring unit 502 at the timing at which the lock/unlock device 100 has unlocked the vehicle 10 with the use of the mobile terminal 200 (step S22).

Initially, in step S41, the interior monitoring unit 502 determines whether another door has been newly opened. When another door has been opened in a state where the vehicle 10 is unlocked by the mobile terminal 200, the process proceeds to step S42.

In step S42, the interior monitoring unit 502 acquires a first image via the camera 503. The first image is an image intended to capture the figure of a person who enters into the vehicle cabin. Thus, in step S42, it is desirable to acquire an image at the timing slightly after a door is opened.

Subsequently, in step S43, the interior monitoring unit 502 determines whether an article has been put in the vehicle cabin. The fact that an article has been put in the vehicle cabin may be determined by, for example, monitoring an output (for example, a measured load) of the sensor 504. When the interior monitoring unit 502 determines that an article has been put in the vehicle cabin, the process proceeds to step S44.

In step S44, the interior monitoring unit 502 acquires a second image via the camera 503. The second image is an image intended to capture a situation at the timing at which the article has been put. Thus, when affirmative determination is made in step S43, it is desirable to immediately acquire an image.

In step S45, the interior monitoring unit 502 determines whether the opened door has been closed. When the opened door has been closed, the process proceeds to step S46.

In step S46, the interior monitoring unit 502 acquires a third image via the camera 503. The third image is an image intended to capture the figure of a person who exits from the vehicle cabin. Thus, it is desirable to acquire an image at the timing slightly before the door is closed. For example, the interior monitoring unit 502 acquires an image captured by the camera 503 approximately several seconds before the designated timing. The acquired first to third images may be stored in a storage medium or may be transmitted via the network. For example, the acquired first to third images may be transmitted to the delivery management server 300 or may be transmitted to a mobile terminal (not shown) held by a consignee.

According to the first embodiment, in the system in which the vehicle 10 is unlocked with the use of the mobile terminal 200, it is possible to capture an image at the timing at which a person or article has entered into the vehicle cabin, an image at the timing at which an article has been put, and an image at the timing at which a person exits from the vehicle cabin. That is, it is possible to check the flow of arrival of shipment with images, and it is possible to monitor unanticipated taking away, or the like, of an article.

In the first embodiment, the timing at which a door is opened and the timing at which the door is closed are used; however, as long as the timing at which the first image is acquired is set in a period from when a door is unlocked to when an article is put and the timing at which the third image is acquired is set in a period from when the article is put to when the door is locked, the timing at which the first image is acquired and the timing at which the third image is acquired are not limited to these timings. For example, the first image may be acquired at the timing several seconds before the timing at which the second image is acquired. Acquisition of any one of the first to third images may be omitted.

### Second Embodiment

In the first embodiment, the fact that an article has been put in the vehicle cabin is detected with the use of the weight sensor. In contrast, in a second embodiment, a sensor that detects an object that has passed through a door is used.

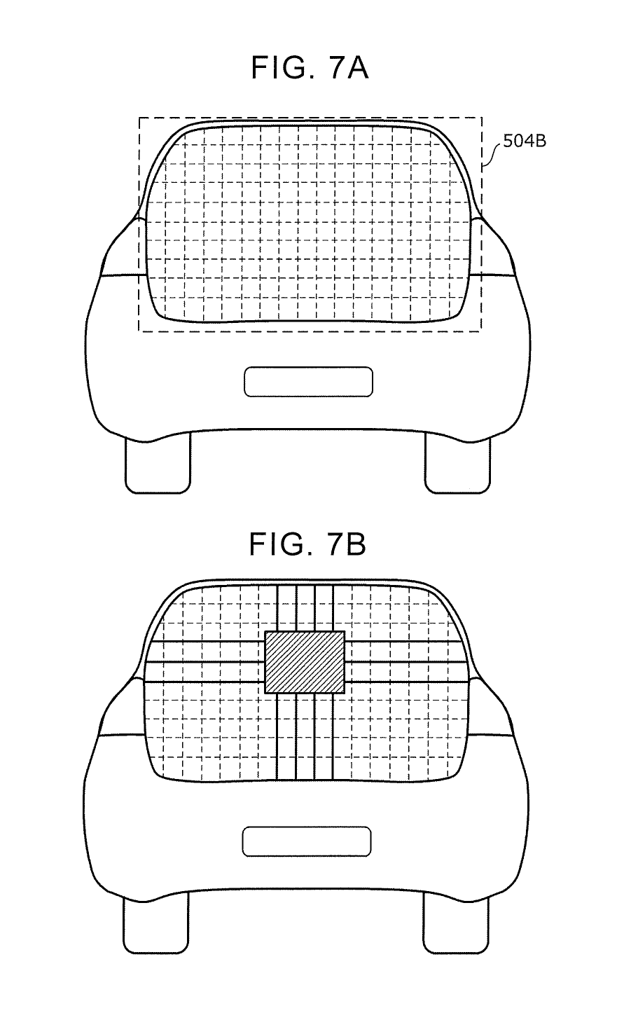

In the second embodiment, the sensor 504 is formed of a weight sensor 504A and a position sensor 504B. The position sensor 504B is a sensor that irradiates infrared rays in a grid pattern along an open plane of a door and that detects a position at which infrared rays are blocked. FIG. 7A is a view that shows the irradiation geometry of infrared rays in the case where the position sensor 504B is disposed at a rear gate of an automobile. The position sensor 504B is formed of a pair of infrared transmitter and infrared receiver. The position sensor 504B is able to output a position in coordinates at which infrared rays are blocked. That is, the position sensor 504B is able to output a position in bitmap information at which an object is present in the door open plane. For example, when infrared rays are blocked at the position indicated by continuous line in FIG. 7B, it may be estimated that an object is present in the region indicated by hatching.

The irradiation geometry of infrared rays and the number of infrared rays may be changed as needed. In this example, the position sensor 504B is disposed at the rear gate. Alternatively, the position sensor 504B may be disposed at another door.

In the second embodiment, in step S41, affirmative determination is made at the timing at which the position sensor 504B has detected an object for the first time. That is, after the door is opened, the first image is acquired at the timing at which the object has entered into the vehicle cabin. In step S45, affirmative determination is made before the door is closed and at the timing at which the position sensor 504B has detected the object for the last time. That is, the third image is acquired at the timing at which the object has exited from the vehicle cabin.

According to the second embodiment, it is possible to detect the timing at which a person or an object has entered into the vehicle cabin and the timing at which the person or the object has exited from the vehicle cabin, so it is possible to acquire images at further appropriate timings.

### Third Embodiment

In a third embodiment, the function of determining whether an article has arrived as scheduled by determining the size of a loaded article is added to the in-vehicle device 500 according to the second embodiment.

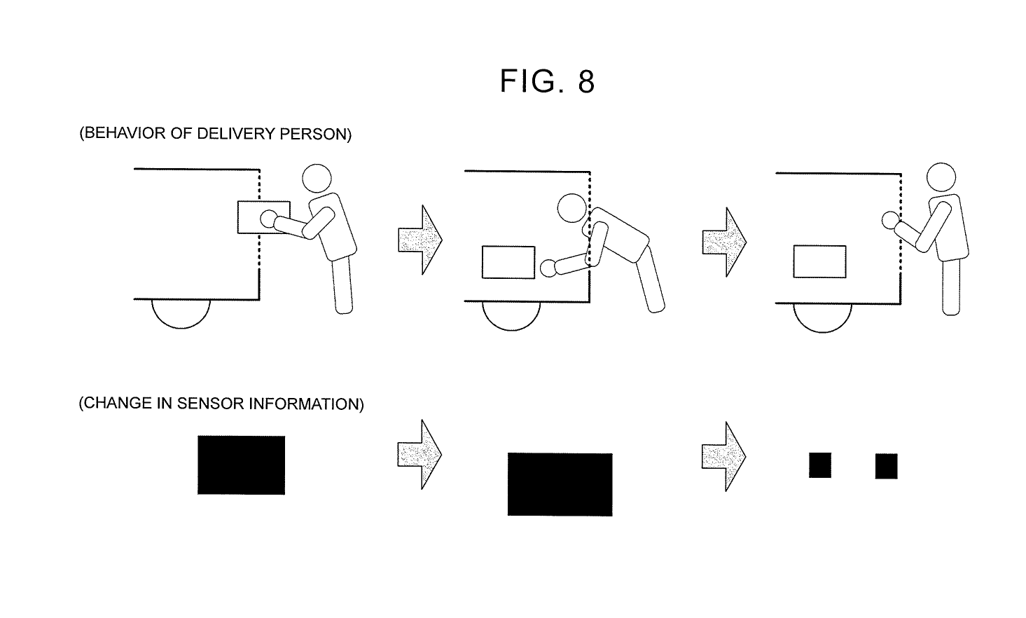

The outline of a method of determining whether an article has arrived as scheduled will be described. FIG. 8 is a view that shows the behavior of a delivery person at the time of loading an article onto a vehicle and a change in sensor information (bitmap information) that the position sensor 504B outputs. As shown in FIG. 8, when a person standing outside the vehicle loads an article into a luggage space, the position sensor 504B initially detects the article and subsequently detects the body of the person. That is, it is possible to estimate the size of a loaded article by acquiring the sectional area of an object that has been detected for the first time since the door was unlocked or opened.

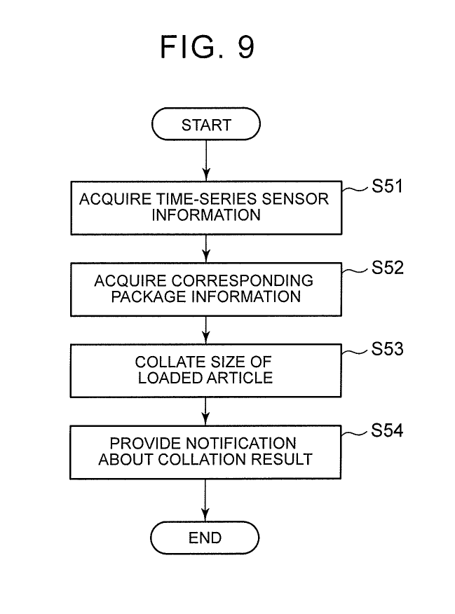

In the third embodiment, the in-vehicle device 500 (interior monitoring unit 502) temporarily stores time-series sensor information (that is, bitmap information) obtained from the position sensor 504B between step S41 and step S45. After the end of step S46, the interior monitoring unit 502 starts the process shown in FIG. 9.

Initially, the interior monitoring unit 502 acquires the temporarily stored time-series sensor information in step S51. Subsequently, in step S52, the interior monitoring unit 502 acquires package information about an article scheduled to arrive from the delivery management server 300. The package information may be acquired in advance. For example, the package information may be stored in the interior monitoring unit 502 at the timing at which device authentication information is stored in the lock/unlock device 100. The package information may be acquired through an input operation of a user (for example, an owner, or the like, of the vehicle).

Subsequently, in step S53, the interior monitoring unit 502 determines whether the sensor information corresponding to the timing of step S41 (for example, the sectional area of the object that has been detected for the first time since the door was unlocked or opened) matches with size information (for example, the total length of three sides or the total length of two sides estimated from the total length of three sides) included in the package information by collating the sensor information with the size information. In step S54, the interior monitoring unit 502 generates the result of the collation, and transmits a notification to a predetermined device. A notification that an article that matches the package information provided in advance has been loaded or a notification that there is any doubt about loading or unloading of an article may be transmitted to, for example, a mobile terminal (not shown) held by a consignee or the delivery management server 300.

In the present embodiment, loading of an article into the vehicle cabin is illustrated. Alternatively, it may be determined whether an article has been unloaded from the vehicle cabin. For example, as shown in FIG. 8, when it is known that hands pass at the end at the time of exiting from the vehicle cabin, sensor information corresponding to the timing of step S45 may be acquired, and the sectional area may be obtained. When an unnaturally large sectional area has been detected, it may be determined that any article has been unloaded.

In the present embodiment, an object that has passed through the door is detected with infrared rays; however, as long as an object that has passed through the door is detectable, a technique other than infrared rays may be used. For example, an ultrasonic distance sensor, or the like, may be used. When infrared rays are irradiated in a grid pattern as shown in FIG. 7A and FIG. 7B, it is not possible to detect the shape of an object recessed inward; however, when a distance sensor, or the like, that irradiates supersonic waves in a grid pattern is used, it is possible to further accurately detect the sectional shape of the object. For example, by determining the likeliness of a rectangular shape in sectional area, it is possible to determine whether a corrugated fiberboard container having a rectangular parallelepiped shape has arrived.

The timing at which an object to be loaded or unloaded is detected may be other than the illustrated timing. For example, sensor information obtained in time series may be analyzed, and the timing at which a shape most likely to be rectangular has been detected may be determined as the timing at which an object to be loaded or unloaded has passed through the door. With such a method, even when loading or unloading is performed with a manner other than the manner shown in FIG. 8 (for example, when a person initially enters into the vehicle and then lifts an article), it is possible to accurately detect the size of an article to be loaded or unloaded.

### Alternative Embodiments

The above-described embodiments are only illustrative. The disclosure may be modified as needed without departing from the scope of the disclosure.

For example, in the description of the embodiments, the vehicle cabin and trunk of an automobile are illustrated as spaces in which an article is allowed to be stored and that are allowed to be locked or unlocked; however, the disclosure is not limited to this configuration. The disclosure is applicable to a device other than an automobile, such as a facility or a storage apparatus, as long as the device has a lockable and unlockable space with the use of a mobile terminal. In the description of the embodiments, the independent in-vehicle device 500 is mounted on the vehicle 10. Alternatively, the in-vehicle device 500 may be incorporated into the vehicle 10.

What is claimed is:

1. A vehicle interior monitoring system installed in a vehicle, a door of the vehicle being configured to be locked or unlocked based on a result of communication with a mobile terminal, the vehicle interior monitoring system comprising:
an image-capturing device configured to capture an image in a vehicle cabin of the vehicle; and
an interior monitoring unit configured to acquire an image captured by the image-capturing device at second timing that comes before a first timing and acquire an image captured by the image-capturing device at third timing that comes after the first timing, the first timing being timing at which it is estimated that the number of articles or a weight of articles in the vehicle cabin has changed.

2. The vehicle interior monitoring system according to claim 1, wherein the interior monitoring unit is configured to further acquire an image captured by the image-capturing device at the first timing.

3. The vehicle interior monitoring system according to claim 1, further comprising a transmitter configured to transmit the images acquired by the interior monitoring unit to a device associated with the vehicle.

4. The vehicle interior monitoring system according to claim 3, wherein the device associated with the vehicle includes a device held by an owner of the vehicle and a device that is managed by a delivery service provider to which a delivery person who holds the mobile terminal belongs.

5. The vehicle interior monitoring system according to claim 1, wherein:
the second timing comes in a period from when the door is unlocked by the mobile terminal until the first timing; and
the third timing comes in a period from the first timing until the door is locked by the mobile terminal.

6. The vehicle interior monitoring system according to claim 1, further comprising a weight sensor provided in the vehicle cabin, characterized in that the interior monitoring unit is configured to determine the first timing based on a signal output from the weight sensor.

7. The vehicle interior monitoring system according to claim 1, further comprising a sensor configured to detect an object that enters or exits via the opened door, wherein:
the second timing is timing at which the object has been detected for a first time after the door is unlocked by the mobile terminal; and
the third timing is timing at which the object has been detected for a last time before the door is locked by the mobile terminal.

8. The vehicle interior monitoring system according to claim 7, wherein
the sensor is configured to acquire a sectional area of the object that has passed through the door, and
the interior monitoring unit is configured to estimate that an article has been properly loaded or unloaded by acquiring, from the sensor, sectional area information of the object that has passed through the door on a time-series basis, and collating the sectional area information with size information of the article scheduled to be loaded into the vehicle or unloaded from the vehicle.

9. The vehicle interior monitoring system according to claim 8, wherein the interior monitoring unit is configured to collate the sectional area information at the second timing with the size information when the article is scheduled to be loaded into the vehicle.

10. A storage apparatus comprising:
a lock and unlock device configured to lock or unlock the storage apparatus based on a result of communication with a mobile terminal;
an estimator configured to estimate that the number of articles or a weight of articles in a predetermined space has changed;
an image-capturing device configured to capture an image in the predetermined space; and
an interior monitoring unit configured to acquire an image captured by the image-capturing device at second timing that comes before a first timing and acquire an image captured by the image-capturing device at third timing that comes after the first timing, the first timing being timing at which it is estimated that the number of articles or the weight of articles has changed.

11. A vehicle comprising:
a lock and unlock device configured to lock or unlock a door of the vehicle based on a result of communication with a mobile terminal;
an estimator configured to estimate that the number of articles or a weight of articles in a vehicle cabin has changed;
an image-capturing device configured to capture an image in the vehicle cabin; and
an interior monitoring unit configured to acquire an image captured by the image-capturing device at second timing that comes before a first timing and acquire an image captured by the image-capturing device at third timing that comes after the first timing, the first timing being timing at which it is estimated that the number of articles or the weight of articles has changed.
